(19) United States
(12) Patent Application Publication
(10) Pub. No.: US 2021/0120230 A1
(43) Pub. Date: Apr. 22, 2021

(54) IMAGE ENCODING CONTROL METHOD AND APPARATUS, STORAGE MEDIUM, AND UNMANNED AERIAL VEHICLE

(71) Applicant: SZ DJI TECHNOLOGY CO., LTD., Shenzhen (CN)

(72) Inventors: Lei ZHU, Shenzhen (CN); Xiufeng GAO, Shenzhen (CN); Maojiang LIN, Shenzhen (CN)

(73) Assignee: SZ DJI TECHNOLOGY CO., LTD., Shenzhen (CN)

(21) Appl. No.: 17/133,399

(22) Filed: Dec. 23, 2020

Related U.S. Application Data
(63) Continuation of application No. PCT/CN2018/096957, filed on Jul. 25, 2018.

(51) Int. Cl. H04N 19/103; H04N 19/124; H04N 19/172; H04N 19/136; H04N 19/146

(52) U.S. Cl. CPC H04N 19/103; H04N 19/124; H04N 19/146; H04N 19/136; H04N 19/172

(57) ABSTRACT

An image encoding control method and device, a storage medium, and an unmanned aerial vehicle (UAV) are disclosed. The method includes: obtaining a frame of image data from an image sequence; encoding the image data for a first time, and obtaining first encoding quality of the image data after the first time encoding; and iteratively encoding the image data based on the first encoding quality and preset target encoding quality. Thus, a frame of image data in an image sequence is obtained and then encoded for the first time, first encoding quality is obtained, and encoding the image data is further controlled based on the first encoding quality and target encoding quality. This effectively solving the problem of a waste of bit rate resources or a shortage of bit rate resources, ensuring encoding quality of images, and meeting requirements of users. Further, the practicability of the method is improved.

### RELATED APPLICATIONS

This application is a continuation application of PCT application No. PCT/CN2018/096957, filed on Jul. 25, 2018, and the content of which is incorporated herein by reference in its entirety.

### TECHNICAL FIELD

The present disclosure relates to the field of information processing technologies, and in particular, to image encoding control methods and devices, storage media, and unmanned aerial vehicles (UAVs).

### BACKGROUND

In video storage and video communication, video compression at a given storage or communication bandwidth is implemented through encoding control over a video compression module. In general cases, compared with a communication scenario, a storage scenarios has higher requirements on the quality of stored videos. However, in conventional encoding control algorithms, generally, bit rate accuracy in a given period of time is used as the only control target.

In addition, during video storage or video communication, time variation complexity and space variation complexity of each video frame are both directly related to a value of a bit rate generated during encoding this frame. In other words, to ensure consistent encoding quality, each frame may actually require a different bit rate. In conclusion, for a high-quality storage scenario, the conventional encoding control algorithm with the constant bit rate as the control target is inefficient, and may have two problems as follows:

(1) When the current frame has low time variation and space variation complexity, to ensure a given quality, an actually required bit rate is lower than a given bit rate. In this case, the conventional encoding control algorithm tends to maintain the given bit rate for encoding, which leads to an excessive bit rate budget for this frame. The excessive budge is actually unnecessary for ensuring the given quality, thus causing a waste of bit rate resources.

(2) When the current frame has high time variation and space variation complexity, to ensure the given quality, an actually required bit rate would be higher than a given bit rate. In this case, the conventional encoding control algorithm tends to maintain the given bit rate for encoding, which leads to an insufficient bit rate budget for this frame. The insufficient budge cannot ensure the given quality, thus causing a shortage of bit rate resources.

### SUMMARY

Exemplary embodiments of the present disclosure provide an image encoding control method and device, a storage medium, and an unmanned aerial vehicle, which can solve the problems of video quality jitter and breathing effect caused by the conventional bit rate control algorithm.

In a first aspect, the present disclosure provides an image encoding control method, including: obtaining a frame of image data from an image sequence; encoding the image data for a first time, and obtaining first encoding quality of the image data after the first time encoding; and iteratively encoding the image data based on the first encoding quality and preset target encoding quality.

In a second aspect, the present disclosure provides an image encoding control device, including: at least one storage medium storing a computer program for encoding images; and at least one processor, to execute the computer program stored in the at least one storage medium to: obtain a frame of image data from an image sequence; encode the image data for a first time, obtain first encoding quality of the image data after the first time encoding; and iteratively encode the image data based on the first encoding quality and preset target encoding quality.

The present disclosure provides an image encoding control method and device, a storage medium, and an unmanned aerial vehicle. A frame of image data in an image sequence is obtained and is encoded for the first time, first encoding quality is obtained, and encoding the image data is further controlled based on the first encoding quality and target encoding quality, so that a single encoding operation or multiple encoding operations can be adaptively selected based on a specific application scenario, thus effectively solving the problem of a waste of bit rate resources or a shortage of bit rate resources, ensuring encoding quality of images, and meeting requirements of users. Further, the practicability of the method is improved, which facilitates marketing and application.

### BRIEF DESCRIPTION OF THE DRAWINGS

FIG. 1 is a schematic flowchart of an image encoding control method according to some exemplary embodiments of the present disclosure;

FIG. 2 is a first schematic flowchart of performing iteratively encoding on image data based on first encoding quality and preset target encoding quality according to some exemplary embodiments of the present disclosure;

FIG. 3 is a second schematic flowchart of performing iteratively encoding on image data based on first encoding quality and preset target encoding quality according to some exemplary embodiments of the present disclosure;

FIG. 4 is a schematic flowchart of controlling iteratively encoding image data based on a target bit rate, a first bit rate and proportion information according to some exemplary embodiments of the present disclosure;

FIG. 5 is a schematic flowchart of another image encoding control method according to some exemplary embodiments of the present disclosure;

FIG. 6 is a schematic flowchart of performing iteratively encoding on image data based on second encoding quality and target encoding quality according to some exemplary embodiments of the present disclosure;

FIG. 7 is a schematic flowchart of still another image encoding control method according to some exemplary embodiments of the present disclosure;

FIG. 8 is a schematic structural diagram of an image encoding control device according to some exemplary embodiments of the present disclosure;

FIG. 9 is a schematic structural diagram of another image encoding control device according to some exemplary embodiments of the present disclosure; and

FIG. 10 is a schematic structural diagram of a UAV according to some exemplary embodiments of the present disclosure.

### DETAILED DESCRIPTION OF THE DRAWINGS AND THE PRESENTLY PREFERRED EMBODIMENTS

In order to make the objects, technical solutions and advantages of the embodiments of the present disclosure clearer, the following clearly and completely describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the scope of protection of the present disclosure.

In the present disclosure, terms such as “mount,” “connect” and “fix” should be understood in a broad sense. For example, a “connection” may be a fixed connection, a removable connection or an integrated connection. A person of ordinary skill in the art may understand specific meanings of the foregoing terms in the present disclosure based on a specific situation.

It should be noted that, in the description of the present disclosure, terms such as “first” and “second” are merely used for describing different components conveniently, and cannot be understood as indicating or implying a sequence relationship or relative importance or implicitly indicating the number of technical features. Therefore, features defined by “first” and “second” may explicitly or implicitly include at least one of the features.

Unless otherwise defined, all technical and scientific terms used herein have the same meaning as commonly understood by persons of ordinary skill in the art to which the present disclosure belongs. The terms used herein are merely for the purpose of describing specific embodiments, and are not intended to limit the present disclosure.

The following describes in detail some exemplary embodiments of the present disclosure with reference to the accompanying drawings. If no conflict occurs, the following exemplary embodiments and features in the exemplary embodiments may be combined.

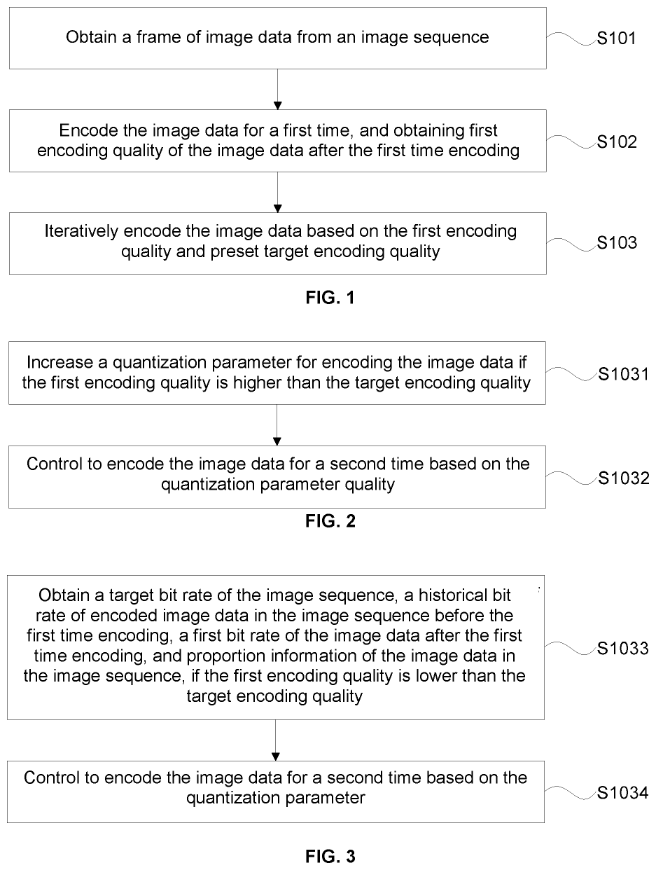

FIG. 1 is a schematic flowchart of an image encoding control method according to some exemplary embodiments of the present disclosure. Referring to FIG. 1, this exemplary embodiment provides an image encoding control method, which can effectively solve the problem of a waste of bit rate resources or a shortage of bit rate resources while ensuring the encoding quality of images. Specifically, the method may include the following steps:

S101: obtain a frame of image data from an image sequence.

An image sequence may include multiple frames of image data. Therefore, one frame of image data may be extracted from the image sequence. This exemplary embodiment does not limit a specific implementation of obtaining a frame of image data, and a person skilled in the art may obtain a frame of image data by using an existing technology. For example, a piece of time information may be obtained first, and a frame of image data corresponding to the time information is then extracted from the multiple frames of image data based on the time information.

S102: encode the image data for a first time, and obtaining first encoding quality of the image data after the first time encoding.

S103: iteratively encode the image data based on the first encoding quality and preset target encoding quality.

The target encoding quality may be a preset default value, or may be preset by a user. In some exemplary embodiments, before the iteratively encoding is performed on the image data based on the first encoding quality and the preset target encoding quality, the image quality of the image sequence may be obtained first; and the target encoding quality is then determined based on this image quality. A feasible implementation manner is: obtaining image quality of the image sequence; and determining the image quality as the target encoding quality.

It is assumed that an image sequence includes N frames of image data, image quality of the image sequence is Q, and the image quality is preset target encoding quality. The Kth frame of image data is extracted from the N frames of image data and then encoded, and first encoding quality Q1 is obtained. Next, iteratively encoding the image data may be controlled based on the first encoding quality Q1 and the target encoding quality Q. For example, Q1 may be compared with Q. When a difference between Q1 and Q is less than a preset threshold, that is, Q1 is close to Q, it indicates that the image data can meet the requirement of a user. Therefore, the encoding operation on the image data may be stopped. When the difference between Q1 and Q is greater than the preset threshold, it indicates that the encoded image data cannot meet the requirement of the user. Therefore, the encoding operation on the image data may be continued.

In addition, another feasible implementation manner for the target encoding quality is: obtaining image quality of the image sequence; determining an image quality range based on the image quality, and determining the image quality range as the target encoding quality.

In this case, when iteratively encoding is performed on the image data based on the first encoding quality Q1 and the target encoding quality Q, Q1 may be compared with Q. When Q1 is within the range of Q, that is, Q1 is close to Q, it indicates that the image data can meet the requirement of the user. Therefore, the encoding operation on the image data may be stopped. When Q1 is not within the range of Q, it indicates that the encoded image data cannot meet the requirement of the user. Therefore, the encoding operation on the image data may be continued. Certainly, a person skilled in the art may use other analysis and processing methods. For example, a ratio of Q1 to Q may be obtained; if the ratio is within a preset standard ratio range, that is, Q1 is close to Q, the encoding operation on the image data may be stopped; if the ratio is not within the preset standard ratio range, the encoding operation on the image data may be continued.

According to the image encoding control method provided in this exemplary embodiment, a frame of image data in an image sequence is obtained and is encoded for the first time, first encoding quality is obtained, and encoding the image data is further controlled based on the first encoding quality and target encoding quality, so that a single encoding operation or multiple encoding operations can be adaptively selected based on a specific application scenario, thus effectively solving the problem of a waste of bit rate resources or a shortage of bit rate resources, ensuring encoding quality of images, and meeting requirements of users. Further, the practicability of the method is improved, which facilitates marketing and application.

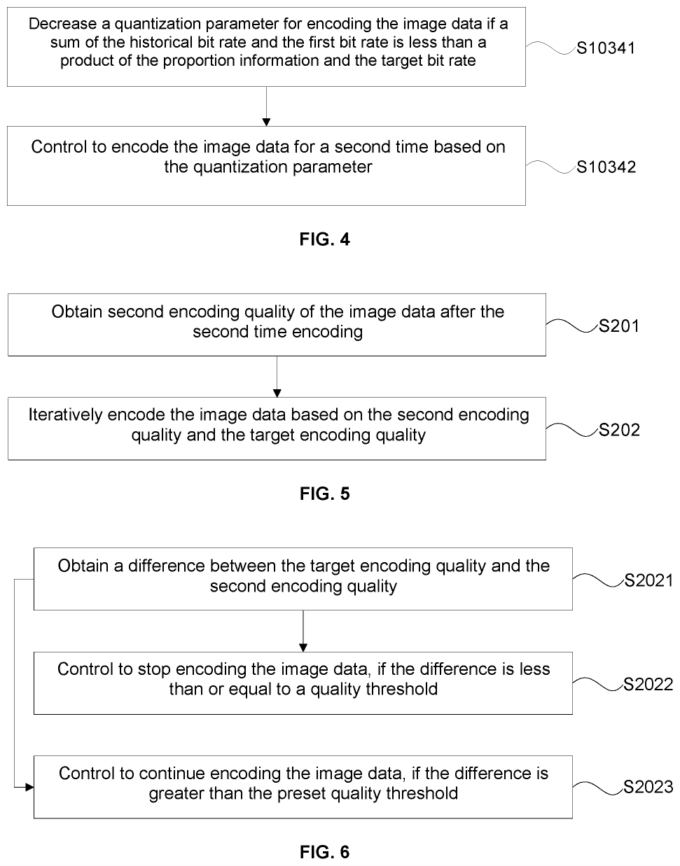

FIG. 2 is a first schematic flowchart of performing iteratively encoding on image data based on first encoding quality and preset target encoding quality according to some exemplary embodiments of the present disclosure; FIG. 3 is a second schematic flowchart of performing iteratively encoding on image data based on first encoding quality and preset target encoding quality according to some exemplary embodiments of the present disclosure; and FIG. 4 is a schematic flowchart of controlling iteratively encoding image data based on a target bit rate, a first bit rate and proportion information according to some exemplary embodiments of the present disclosure. Based on the foregoing exemplary embodiment, with reference to FIG. 2 to FIG. 4, the step of performing iteratively encoding on the image data according to the first encoding quality and preset target encoding quality in this exemplary embodiment may specifically include the following steps:

S1031: increase a quantization parameter for encoding the image data if the first encoding quality is higher than the target encoding.

After the first encoding quality and the target encoding quality are obtained, values of the first encoding quality and the target encoding quality may be compared. When the first encoding quality is greater than the target encoding quality, it indicates that the image data after being encoded cannot meet the requirement of the user. Therefore, to meet the requirement of the user, encoding the image data needs to be continued. In this case, the quantization parameter for encoding the image data needs to be increased, so that the encoding operation is performed again with the increased quantization parameter. An increment granularity of the quantization parameter may be any one from 1 to 51. This exemplary embodiment does not limit the increment granularity of the quantization parameter, and a person skilled in the art may set the increment granularity according to a specific design requirement. For example, the quantization parameter may be increased based on a preset increment granularity, where the preset increment granularity may be 1, 2, 3, 4, 5, 6, 7, 8 or other customized values.

It should be noted that, an increase in the quantization parameter reduces the bit rate of the image data and also reduces the image quality. On the contrary, a decrease in the quantization parameter increases the bit rate of the image data and also increases the image quality.

S1032: control to encode the image data for a second time based on the quantization parameter quality.

After the quantization parameter is increased, the second encoding operation may be performed on the image data based on the increased quantization parameter, so as to meet the requirement of the user.

In addition, the step of performing iteratively encoding on the image data based on the first encoding quality and preset target encoding quality may further include the following steps:

S1033: obtain a target bit rate of the image sequence, a historical bit rate of encoded image data in the image sequence before the first time encoding, a first bit rate of the image data after the first time encoding, and proportion information of the image data in the image sequence, if the first encoding quality is lower than the target encoding quality.

When the first encoding quality is lower than the target encoding quality, it cannot be accurately determined whether the encoded image data meets the requirement of the user. Therefore, to accurately determine whether the encoded image data meets the requirement of the user, the target bit rate, the historical bit rate, the first bit rate, and the proportion information may be obtained, and the image data is then analyzed based on an analysis result of the foregoing parameters.

S1034: control to encode the image data for a second time based on the quantization parameter.

After being obtained, the target bit rate, the historical bit rate, the first bit rate, and the proportion information may be analyzed, to determine whether the encoded image data meets the requirement of the user. The step of controlling the iteratively encoding the image data based on the target bit rate, the historical bit rate, the first bit rate, and the proportion information may include the following steps:

S10341: decrease a quantization parameter for encoding the image data if a sum of the historical bit rate and the first bit rate is less than a product of the proportion information and the target bit rate.

Specifically, it is assumed that the target bit rate is R, the historical bit rate of encoded image data in the image sequence before the image data is encoded for the first time is Rn, the first bit rate is RK1, and the proportion information is K/N. When Rn+RK1<(R/N)*K, the encoded image data does not meet the requirement of the user. Therefore, to meet the requirement of the user, encoding the image data needs to be continued. Further, the quantization parameter for encoding the image data needs to be decreased, so that the encoding operation is performed again by using the decreased quantization parameter. A decrement granularity of the quantization parameter may be any one from 1 to 51. A person skilled in the art may set the decrement granularity according to a specific design requirement, and details will not be described herein.

S10342: control to encode the image data for a second time based on the quantization parameter.

After the quantization parameter is decreased, the second encoding operation may be performed on the image data based on the decreased quantization parameter, so to meet the requirement of the user.

Further, the step of controlling the iteratively encoding the image data based on the target bit rate, the historical bit rate, the first bit rate, and the proportion information may include the following step:

S10343: control to stop encoding the image data if the sum of the historical bit rate and the first bit rate is equal to the product of the proportion information and the target bit rate.

When Rn+RK1=(R/N)*K, it may be determined that the image data at this point can meet the requirement of the user. Therefore, encoding the image data may be controlled to stop.

Further, the step of performing iteratively encoding on the image data based on the first encoding quality and the preset target encoding quality may further include the following step:

S1035: control to stop encoding the image data if the first encoding quality is equal to the target encoding quality.

When the first encoding quality is equal to the target encoding quality, it may be determined that the image data at this point can meet the requirement of the user. Therefore, encoding the image data may be controlled to stop.

Through the foregoing method, the encoding operation on the image data is controlled based on the first encoding quality and the target encoding quality, which can ensure the stability and reliability of encoding the image data while meeting the requirement of the user, thereby further improving the practicability of the method.

FIG. 5 is a schematic flowchart of another image encoding control method according to some exemplary embodiments of the present disclosure; FIG. 6 is a schematic flowchart of performing iteratively encoding on image data based on second encoding quality and target encoding quality according to some exemplary embodiments of the present disclosure. Based on the foregoing exemplary embodiment, with reference to FIG. 5 and FIG. 6, in this exemplary embodiment, after the step of controlling to encode the image data for the second time based on the quantization parameter, the method further includes the following steps:

S201: obtain second encoding quality of the image data after the second time encoding.

After the image data is encoded for the second time, it needs to determine whether the image data after being encoded for the second time meets the requirement of the user. Therefore, the second encoding quality of the image data after being encoded for the second time can be obtained.

S202: iteratively encode the image data based on the second encoding quality and the target encoding quality.

After the second encoding quality is obtained, the image data may be analyzed with the second encoding quality and the target encoding quality obtained in advance. Specifically, the step of performing iteratively encoding on the image data based on the second encoding quality and the target encoding quality may include the following steps:

S2021: obtain a difference between the target encoding quality and the second encoding quality.

S2022: control to stop encoding the image data, if the difference is less than or equal to a quality threshold.

The quality threshold may be preset. A person skilled in the art may set the quality threshold according to a specific design requirement. It should be noted that, a value or a value range of the quality threshold is relatively small. When the difference between the target encoding quality and the second encoding quality is lower than or equal to the preset quality threshold, it indicates that the second encoding quality is close to the target encoding quality, and the image data at this point can meet the requirement of the user. Therefore, the encoding operation on the image data may be stopped.

S2023: control to continue encoding the image data, if the difference is greater than the preset quality threshold.

When the difference between the target encoding quality and the second encoding quality is greater than the preset quality threshold, it indicates that the second encoding quality is significantly different from the target encoding quality. The image data at this point cannot meet the requirement of the user. Therefore, the encoding operation on the image data may be continued, and the number of encoding operations may be determined according to a requirement of an actual scenario.

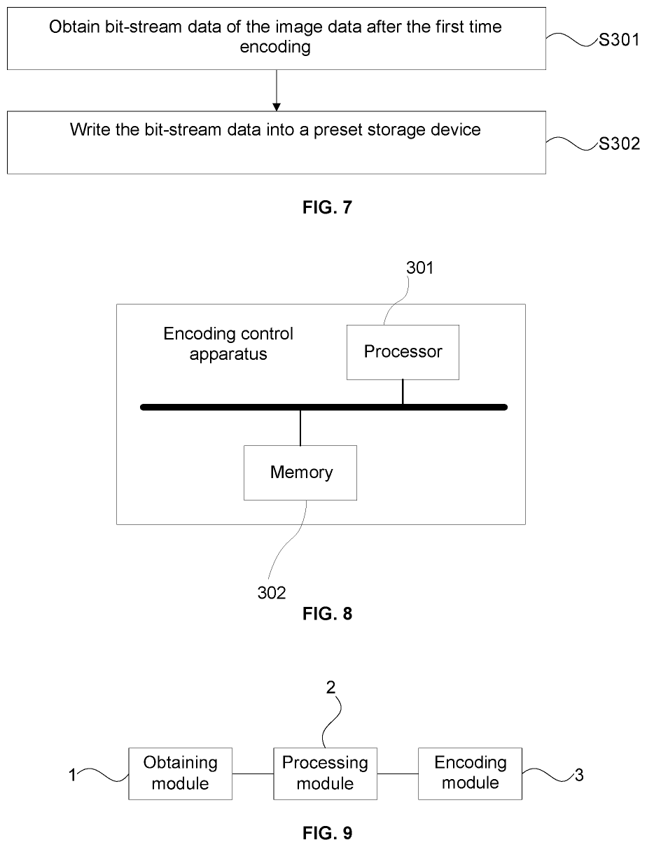

FIG. 7 is a schematic flowchart of still another image encoding control method according to some exemplary embodiments of the present disclosure. Based on the foregoing embodiment, with reference to FIG. 7, to improve the practicability of the method, in this exemplary embodiment, after the step of performing iteratively encoding on the image data based on the first encoding quality and preset target encoding quality, the method may further include the following steps:

S301: obtain bit-stream data of the image data after the first time encoding.

S302: write the bit-stream data into a preset storage device.

The preset storage device may include a memory, a hard disk, a floppy disk, a magnetic disk, a USB flash disk, an optical memory, and the like. The memory may include a random access memory (RAM), a read-only memory (ROM) or the like. The optical memory may include a compact disc (CD), a digital versatile disk (DVD), or the like. The image data meeting the requirement of the user is written into the storage device, so that the user can retrieve, manage and store the image data conveniently, thereby improving the user convenience.

In a specific application, some exemplary embodiments of this application provide an image encoding control method. Specifically, it is assumed that a target bit rate of an N-frame image sequence in a given period of time is R, and target encoding quality is Q. The Kth frame of image data in the N-frame image sequence is obtained, where K<N. After the frame of image data is encoded for the first time, a bit rate and encoding quality of the encoded image data are obtained, namely, a first bit rate R1 and first encoding quality Q1. Then, an analysis is carried out according to the target bit rate R, the target encoding quality Q, the first bit rate R1, and the first encoding quality Q1. Specific analysis steps are as follows:

(1) If Q1>Q, a quantization parameter of encoding is increased, and encoding is performed again, so that Q2˜Q, that is, second encoding quality obtained after the second encoding operation is infinitely close to the target encoding quality. In this case, the first bit rate R1 is also reduced to a second bit rate R2. Specifically, the number of repetitions may be determined according to the requirement of an actual scenario, so that final Q[k] infinitely approaches Q.

A specific application scenario is as follows: when a photographing device (such as a camera or a terminal with a camera function) shoots images, each time the photographing device captures a frame of image, it is necessary to perform encoding and storing operations. Each encoding operation of the photographing device requires a corresponding processing time and processing power consumption. Therefore, the processing time, the processing power consumption, and image quality obtained need to be taken into consideration comprehensively to determine whether the image data can meet the requirement of the user. That is, image data with relatively high quality needs to be obtained while the processing time and processing power consumption are within a range acceptable to the user. Specifically, the number of repeated encoding operations may be determined according to the requirement of an actual scenario.

(2) When Q1<Q, the following specific analysis process may be performed:

(a) If Rn+R1<(R/N)*K, the quantization parameter of encoding is decreased, and encoding is performed again, so that Q2˜Q. The first bit rate R1 also rises to the second bit rate R2. Specifically, the number of repetitions may be determined according to a requirement of an actual scenario. Moreover, on the premise that Rn<R˜R[k], final Q[k] is made to infinitely approach Q, where R[k] is a bit rate after the image data is encoded for the Kth time, and Q[k] is encoding quality after the image data is encoded for the Kth time.

(b) If Rn+R1=(R/N)*K, the encoding operation is stopped.

(3) When Q1=Q, the encoding operation is stopped.

It should be noted that, during the encoding operation on the image data, the bit rate of the image sequence after the encoding changes based on the encoding operation, that is, Rn=Rn+R[k], where Rn is a historical bit rate of encoded image data in the image sequence before the image data is encoded for the Kth time, and R[k] is a bit rate after the image data is encoded for the Kth time.

In addition, the adjustment of the quantization parameter in this exemplary application embodiment mainly refers to adjusting the quantization parameter used in next encoding based on the quantization parameter used during the first encoding, the first bit rate, and the first encoding quality. The granularity for the adjustment of the quantization parameter is not limited. Generally, for the quantization parameter in the encoding standards H.264 and H.265, it is defined that for video images of the same scenario, the bit rate is reduced by half and the objective quality PSNR is reduced by 3 dB each time the quantization parameter is increased by 6. It may be appreciated that, for implementations of different scenarios, videos of different motions, and different specific encoding algorithms, the foregoing theoretical experience is merely reference data. In addition, in most scenarios in practical use, the image data basically can meet the requirement after being encoded for the second time. Even if there is a slight deviation, it is acceptable to the user or product, and it is unnecessary to perform encoding for the third time.

This exemplary embodiment adopts an encoding control method based on adaptive selection of a single encoding operation or multiple encoding operations, and aims at optimizing video quality at a given bit rate, which can solve the problems of video quality jitter and breathing effect caused by the conventional bit rate control algorithm. The encoding control method in this exemplary embodiment aims at the smoothness of the quality rather than the smoothness of the bit rate, so that optimal quality can be achieved at the given bit rate, thus meeting the requirement of users. The practicability of the method is further improved, which facilitates marketing and application.

FIG. 8 is a schematic structural diagram of an image encoding control device according to exemplary embodiments of the present disclosure. Referring to FIG. 8, this exemplary embodiment provides an image encoding control device. The encoding control device may perform the foregoing encoding control method. Specifically, the encoding control device may include:

at least one memory/storage medium 302, configured to store a computer program/set of instructions; and

at least one processor 301, configured to execute the computer program/set of instructions stored in the memory 302 to implement the following operations: obtaining a frame of image data from an image sequence; encoding the image data for the first time, obtaining first encoding quality of the encoded image data; and performing iteratively encoding on the image data based on the first encoding quality and preset target encoding quality.

Before the processor 301 performs iteratively encoding on the image data according to the first encoding quality and the preset target encoding quality, the processor 301 is configured to: obtain image quality of the image sequence; and determine the image quality as the target encoding quality.

Further, when the processor 301 performs iteratively encoding on the image data according to the first encoding quality and the preset target encoding quality, the processor 301 is configured to:

increase a quantization parameter for encoding the image data if the first encoding quality is greater than the target encoding quality; and control to encode the image data for the second time based on the quantization parameter.

In addition, when the processor 301 performs iteratively encoding on the image data based on the first encoding quality and the preset target encoding quality, the processor 301 is configured to:

obtain a target bit rate of the image sequence, a historical bit rate of encoded image data in the image sequence before the image data is encoded for the first time, a first bit rate of the image data after being encoded, and proportion information of the image data in the image sequence, if the first encoding quality is lower than the target encoding quality; control the iteratively encoding of the image data according to the target bit rate, the historical bit rate, the first bit rate, and the proportion information.

Specifically, when the processor 301 controls the iteratively encoding of the image data based on the target bit rate, the historical bit rate, the first bit rate, and the proportion information, the processor 301 is configured to:

decrease the quantization parameter for encoding the image data if a sum of the historical bit rate and the first bit rate is less than a product of the proportion information and the target bit rate; and control to encode the image data for the second time based on the quantization parameter.

When the processor 301 controls the iteratively encoding of the image data based on the target bit rate, the historical bit rate, the first bit rate, and the proportion information, the processor 301 is configured to:

control to stop encoding the image data if the sum of the historical bit rate and the first bit rate is equal to the product of the proportion information and the target bit rate.

Further, after the processor 301 controls to encode the image data for the second time based on the quantization parameter, the processor 301 is configured to:

obtain second encoding quality of the image data after the encoding; and perform iteratively encoding on the image data based on the second encoding quality and the target encoding quality.

When the processor 301 performs iteratively encoding on the image data based on the second encoding quality and the target encoding quality, the processor 301 is configured to:

obtain a difference between the target encoding quality and the second encoding quality; control to stop encoding the image data if the difference is less than or equal to a preset quality threshold; or control to continue encoding the image data if the difference is greater than the preset quality threshold.

In addition, when the processor 301 iteratively encoding the image data based on the first encoding quality and the preset target encoding quality, the processor 301 is configured to:

control to stop encoding the image data if the first encoding quality is equal to the target encoding quality.

Further, after the processor 301 iteratively encoding the image data based on the first encoding quality and the preset target encoding quality, the processor 301 is configured to:

obtain bit-stream data of the image data encoded; and write the bit-stream data into a preset storage device.

The image encoding control device in some exemplary embodiment may be configured to perform the technical solutions of the embodiments shown in FIG. 1 to FIG. 7 in the foregoing methods, and has a similar implementation principle and technical effects, which will not be described in detail herein.

FIG. 9 is a schematic structural diagram of another image encoding control device according to some exemplary embodiments of the present disclosure. Referring to FIG. 9, this exemplary embodiment provides another image encoding control device. The encoding control device may perform the foregoing encoding control method. Specifically, the encoding control device may include:

an obtaining module 1, configured to obtain a frame of image data from an image sequence;

a processing module 2, configured to encode the image data for the first time, and obtain first encoding quality of the encoded image data; and

an encoding module 3, configured to iteratively encode the image data based on the first encoding quality and preset target encoding quality.

The obtaining module 1, the processing module 2 and the encoding module 3 in the image encoding control device in this exemplary embodiment may be configured to perform the technical solutions of the embodiments shown in FIG. 1 to FIG. 7 in the foregoing methods, and has a similar implementation principle and technical effects, which will not be described in detail herein.

According to another aspect of this exemplary embodiment, a computer readable storage medium is provided. The computer readable storage medium stores program or a set of instructions that are configured to implement the image encoding control method according to any of the foregoing embodiments.

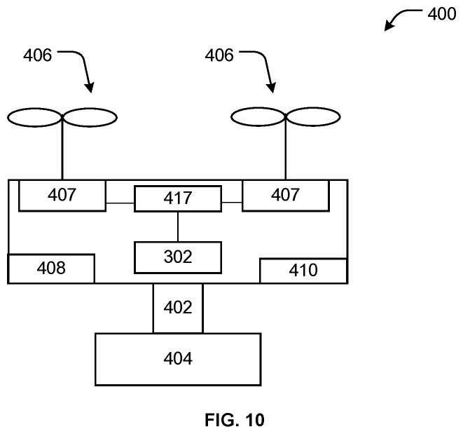

FIG. 10 is a schematic structural diagram of a UAV according to some exemplary embodiments of the present disclosure. Referring to FIG. 10, this exemplary embodiment provides a UAV 400, including:

a frame; and

an encoding control device 302 according to any of the foregoing embodiments, where the encoding control device 302 is disposed on the frame.

The UAV 400 includes: a body, a power system, and the encoding control device 302. The power system includes at least one of the following: a motor 407, a propeller 406, and an electronic speed adjustor 417. The power system may be installed on the body and configured to provide flight power. The encoding control device 302 may be disposed on the body. The implementation manner and specific principle of the encoding control device 302 are the same as those of the control device in the foregoing embodiment, which will not be described in detail herein.

In addition, the UAV 400 further includes: a sensing system 408, a communication system 410, a support device 402, and a photographing device 404, where the support device 402 may be specifically a gimbal and the communication system 410 may be specifically configured to communicate with a ground control terminal.

In some exemplary embodiments, the encoding control device 302 may be specifically an image processor. The image processor may be communicatively connected to the photographing device 404, to process image data captured by the photographing device 404.

If no conflict occurs, the technical solutions and technical features in the foregoing embodiments may be used alone or in combination, which all belong to equivalent embodiments within the scope of protection of the present disclosure provided as long as they do not go beyond the comprehension of a person skilled in the art.

In the exemplary embodiments provided in the present disclosure, it should be understood that the related device and method disclosed may be implemented in other manners. The described device embodiment is merely an example. For example, the module or unit division is merely a logical function division, and there may be may be other division manners in actual implementation. For example, a plurality of units or components may be combined or integrated into another system, or some features may be omitted or may not be performed. In addition, couplings or direct couplings or communication connections shown or discussed may be implemented with some interfaces. The indirect couplings or communication connections between devices or units may be implemented in electric, mechanical, or other forms.

The units described as separate parts may or may not be physically separate, and parts shown as units may or may not be physical units; they may be located in one position, or may be distributed to a plurality of network elements. Some or all of the units may be selected based on actual requirements to achieve the objects of the solutions of the embodiments.

In addition, functional units in the embodiments of the present disclosure may be integrated into one processing unit, or each of the units may exist alone physically, or two or more units may be integrated into one unit. The foregoing integrated unit can be implemented either in the form of hardware or in the form of software functional units.

The integrated unit, if implemented in the form of a software functional unit and sold or used as a stand-alone product, may be stored in a computer-readable storage medium. Based on such an understanding, the technical solution of the present disclosure essentially, or a part thereof contributing to the existing technology, or a part or all of the technical solution may be embodied in the form of a software product. The computer software product may be stored in a storage medium and includes a plurality of instructions for causing a computer processor 101 to execute all or some steps of the method according to the embodiments of the present disclosure. The aforementioned storage medium may include: a USB flash disk, a mobile hard disk, a read-only memory (ROM), a random access memory (RAM), a magnetic disk, an optical disc, or other media capable of storing program code.

The foregoing description is merely some exemplary embodiments of the present disclosure and does not constitute a limitation on the scope of the present disclosure. Any equivalent structure or equivalent process change based on the description and the accompanying drawings of the present disclosure, or a direct or indirect application thereof in other related technical fields, shall still fall within the scope of protection of the present disclosure.

Finally, it should be noted that the foregoing embodiments are merely intended for describing the technical solutions of the present disclosure, but not for limiting the present disclosure. Although the present disclosure is described in detail with reference to the foregoing embodiments, a person of ordinary skill in the art should understand that they may still make modifications to the technical solutions described in the foregoing embodiments or make equivalent replacements to some or all technical features, without causing the essence of the corresponding technical solutions to depart from the scope of the technical solutions of the embodiments of the present disclosure.

What is claimed is:

1. An image encoding control method, comprising:
obtaining a frame of image data from an image sequence;
encoding the image data for a first time, and obtaining first encoding quality of the image data after the first time encoding; and
iteratively encoding the image data based on the first encoding quality and preset target encoding quality.

2. The method according to claim 1, further comprising: before the iteratively encoding of the image data based on the first encoding quality and the preset target encoding quality,
obtaining image quality of the image sequence; and
determining the image quality as the preset target encoding quality.

3. The method according to claim 2, wherein the iteratively encoding of the image data based on the first encoding quality and the preset target encoding quality includes:
increasing a quantization parameter for encoding the image data in response to the first encoding quality being higher than the target encoding quality; and
encoding of the image data for a second time based on the quantization parameter.

4. The method according to claim 2, wherein the iteratively encoding of the image data based on the first encoding quality and the preset target encoding quality includes:
obtaining a target bit rate of the image sequence, a historical bit rate of encoded image data in the image sequence before the first time encoding, a first bit rate of the image data after the first time encoding, and proportion information of the image data in the image sequence, after determining the first encoding quality is lower than the target encoding quality; and
iteratively encoding of the image data based on the target bit rate, the historical bit rate, the first bit rate and the proportion information.

5. The method according to claim 4, wherein the iteratively encoding of the image data based on the target bit rate, the historical bit rate, the first bit rate and the proportion information includes:
decreasing a quantization parameter for encoding the image data after determining a sum of the historical bit rate and the first bit rate is less than a product of the proportion information and the target bit rate; and
encoding the image data for a second time based on the quantization parameter.

6. The method according to claim 4, wherein the iteratively encoding of the image data based on the target bit rate, the historical bit rate, the first bit rate and the proportion information includes:
stopping encoding the image data after determining a sum of the historical bit rate and the first bit rate is equal to a product of the proportion information and the target bit rate.

7. The method according to claim 3, further comprising, after the encoding of the image data for a second time based on the quantization parameter:
obtaining second encoding quality of the image data after the second time encoding; and
iteratively encoding the image data based on the second encoding quality and the target encoding quality.

8. The method according to claim 7, wherein the iteratively encoding of the image data based on the second encoding quality and the target encoding quality includes:
obtaining a difference between the target encoding quality and the second encoding quality, and stopping encoding the image data after determining the difference is less than or equal to a quality threshold; or
obtaining a difference between the target encoding quality and the second encoding quality, and continuing encoding the image data after determining the difference is greater than the preset quality threshold.

9. The method according to claim 2, wherein the iteratively encoding of the image data based on the first encoding quality and the preset target encoding quality further includes:
stopping encoding the image data in response to the first encoding quality being equal to the target encoding quality.

10. The method according to claim 1, further comprising, after iteratively encoding of the image data based on the first encoding quality and the preset target encoding quality:
obtaining bit-stream data of the image data after the first time encoding; and
writing the bit-stream data into a preset storage device.

11. An image encoding control device, comprising:
at least one storage medium storing a computer program for encoding images; and
at least one processor, to execute the computer program stored in the at least one storage medium to:
obtain a frame of image data from an image sequence;
encode the image data for a first time,
obtain first encoding quality of the image data after the first time encoding; and
iteratively encode the image data based on the first encoding quality and preset target encoding quality.

12. The device according to claim 11, wherein before the processor iteratively encoding the image data based on the first encoding quality and the preset target encoding quality, the at least one processor further executes the computer program to:
obtain image quality of the image sequence; and
determine the image quality as the preset target encoding quality.

13. The device according to claim 12, wherein to iteratively encode the image data based on the first encoding quality and the preset target encoding quality, the at least one processor further executes the computer program to:
increase a quantization parameter for encoding the image data after determining that the first encoding quality is higher than the target encoding quality; and
encode the image data for a second time based on the quantization parameter.

14. The device according to claim 12, wherein to iteratively encode the image data based on the first encoding quality and the preset target encoding quality, the at least one processor further executes the computer program to:
obtain a target bit rate of the image sequence, a historical bit rate of encoded image data in the image sequence before the first time encoding, a first bit rate of the image data after the first time encoding, and proportion information of the image data in the image sequence, after determining the first encoding quality is lower than the target encoding quality; and
iteratively encode the image data based on the target bit rate, the historical bit rate, the first bit rate, and the proportion information.

15. The device according to claim 14, wherein to iteratively encode the image data based on the target bit rate, the historical bit rate, the first bit rate and the proportion information, the at least one processor further executes the computer program to:
decrease a quantization parameter for encoding the image data after determining a sum of the historical bit rate and the first bit rate is less than a product of the proportion information and the target bit rate; and
encode the image data for a second time based on the quantization parameter.

16. The device according to claim 14, wherein to iteratively encode the image data based on the target bit rate, the historical bit rate, the first bit rate and the proportion information, the at least one processor further executes the computer program to:
stop encoding the image data after determining a sum of the historical bit rate and the first bit rate is equal to a product of the proportion information and the target bit rate.

17. The device according to claim 13, wherein encoding the image data for a second time based on the quantization parameter, the at least one processor further executes the computer program to:
obtain second encoding quality of the image data after the second time encoding; and
iteratively encode the image data based on the second encoding quality and the target encoding quality.

18. The device according to claim 17, wherein to iteratively encode the image data based on the second encoding quality and the target encoding quality, the at least one processor further executes the computer program to:
obtain a difference between the target encoding quality and the second encoding quality, and stop encoding the image data after determining the difference is less than or equal to a quality threshold; or
obtain a difference between the target encoding quality and the second encoding quality, and continue encoding the image data after determining the difference is greater than the preset quality threshold.

19. The device according to claim 12, wherein to iteratively encode the image data based on the first encoding quality and the preset target encoding quality, the at least one processor further executes the computer program to:
stop encoding the image data after determining that the first encoding quality is equal to the target encoding quality.

20. The device according to claim 11, wherein after iteratively encoding the image data based on the first encoding quality and the preset target encoding quality, the at least one processor further executes the computer program to:
obtain bit-stream data of the image data after the first time encoding; and
write the bit-stream data into a preset storage device.
